(19) United States
(12) Patent Application Publication
(10) Pub. No.: US 2003/0102013 A1
(43) Pub. Date: Jun. 5, 2003

(54) Prophylactic process and apparatus for a substrate treated with an impingement spray

(76) Inventor: David P. Jackson, Saugus, CA (US)

Correspondence Address: SONNENSCHEIN NATH & ROSENTHAL, Suite 1500, 601 So. Figueroa Street, Los Angeles, CA, 90017, US

(21) Appl. No.: 10/005,372

(22) Filed: Dec. 3, 2001

(51) Int. Cl. B08B 7/04

(52) U.S. Cl. 134/21; 134/30; 134/37; 134/95.3

(57) ABSTRACT

The present invention is a method and apparatus for treating a substrate using an impingement cryogenic or steam spray jet whereas a substrate is first encased in a prophylactic device whereupon the substrate is continuously bathed in a counterflowing stream of ULPA-filtered, inert, dry, heated and ionized gas which bathes both the posterior and anterior regions of the critical substrate surface to be treated—precluding the intrusion of contaminating atmospheres onto critical surfaces. This creates an in-situ microenvironment within which the substrate surface is treated with said impinging treatment spray. The treated surface is thus isolated and protected from the ambient atmosphere and contaminants contained therein prior to, during and following application of a treatment spray without causing a direct impingement of a protective atmosphere upon a critical surface. The critical substrate surfaces being treated are continuously supplied heat, ions and a diluting atmosphere through molecular diffusion phenomenon rather than through direct impingement purging, drying or ion bombardment, thereby minimizing or eliminating the creation or introduction of contaminants into or within the cleaning zone. The present invention allows for the simultaneous application of a variety of conventional surface treatment agents such as dry steam or snow to a critical surface while controlling and maintaining the quality of the environment immediately within the vicinity of the critical surface being treated.

### BACKGROUND OF INVENTION

The present invention relates generally to the field of cleaning or treating miniature electromechanical device surfaces with cryogenic impingement sprays. More specifically, the present invention relates to the field of environmental control for performing cryogenic spray cleaning processes. Conventional precision cleaning processes using cryogenic particle impingement sprays such as solid phase carbon dioxide require control of the atmosphere containing a treated substrate to prevent the deposition of moisture, particles and other such contaminants onto cleaned surfaces during and following cleaning treatments. Environmental control is required because of localized atmospheric perturbations created by the low temperatures and high velocities which are characteristic of these impingement cleaning sprays.

For example, snow particles having a surface temperature of −100 F and traveling through the space between the spray nozzle and substrate are continuously sublimating in transit and upon impact with a substrate surface. This rapidly lowers local ambient atmospheric temperature—causing the contaminants contained therein to condense or “rain-out” of the local atmosphere and onto treated substrate surfaces during or following spray treatments. Moreover, the cleaning spray stream exhibits lower internal pressure than the surrounding atmosphere (Bernoulli Principle) and creates venturi currents adjacent to the flow of the stream. These venturi currents cause the local atmosphere surrounding the stream to collapse into the spray stream above the substrate—thus entraining and delivering a mixture of cleaning spray and atmospheric constituents to the substrate. Finally, static charge build-up and accumulation are common to cryogenic sprays due the dielectric and tribocharging characteristics. This presents two problems—potential device damage from electrostatic overstress (EOS) or discharge (ESD) events and attraction of atmospheric contaminants to treated substrates via electrostatic attractive forces.

Several techniques have been proposed to control thermal and electrostatic effects during cryogenic impingement sprays using secondary heated or ionized jets or sprays above the substrate surface and delivered either independently or as a component of the cryogenic spray. In U.S. Pat. No. 5,409,418 and U.S. Pat. No. 5,354,384, both teach direct heated or ionized gas impingement techniques and apparatus for heating, purging and deionizing substrate surfaces.

'384 teaches the use of a heated gas such as filtered nitrogen to provide a preheat cycle to a portion of a substrate prior to snow spray cleaning the same portion of said substrate, and a post-heat cycle of same said portion following snow cleaning. This approach relies on “banking heat” into the substrate portion prior to cryogenic spray cleaning by delivering a heated gas stream to a portion of substrate to prevent moisture deposition and adding heat from a heated gas following cryogenic spray treatment. The '384 invention is primarily useful for removing high molecular weight materials such as waxes and adhesive residues from surfaces by partially melting or softening them prior to spray treatment—in essence weakening cohesive energy. However, this approach does not work well for most substrate treatment applications because many materials, or the portions thereof, being cleaned have low thermal conductivity and low mass or because highly thermal conductive materials rapidly lose heat to the sublimating snow during impact—creating localized cold spots on even a mostly hot bulk substrate. This is the case for many substrates and surfaces being treated. Examples include ceramics, glasses, silicon and other semi-conductor materials, as well as most polymers. In addition, many electromechanical devices being cleaned are very small—providing no appreciable mass for storing heat. Examples include photodiodes, fiber optic connectors, optical fibers, end-faces, sensors, dies, and CCD's, among many others.

Most significantly, directing a heating spray, or any secondary fluid for that matter, directly at or incident with the substrate surface to be cleaned prior to, during and/or following cryogenic cleaning spray treatments causes the entrainment, delivery and deposition of atmospheric contaminants as discussed above. This necessitates housing the cryogenic spray applicator, substrate and secondary gas jets in large, bulky and complex environmental enclosures employing HEPA filtration and dry inert atmospheres such as taught for example in U.S. Pat. No. 5,315,793, which teaches a fully enclosed environmental chamber containing a snow spray applicator and heating system.

In the '418 invention, an apparatus is taught for surrounding the impinging cryogenic spray stream with an ionized inert gas. Using this invention, it is proposed that by surrounding a stream of solid-gas carbon dioxide with a circular stream of ionized gas and applying the two components to the substrate simultaneously controls or eliminates ESD at the surface during impingement. However, as also with '384 invention above, the '418 secondary stream entrains, delivers and deposits atmospheric contaminants upon the substrate surfaces being treated. Moreover, contact of the ionizing gas with the stream prior to contact with the surface rapidly eliminates ion concentration—highly degrading the performance of such an approach to controlling ESD. Still moreover, using the ionizing spray of '418 independent of the snow spray and which is directed at an angle which is incident to the surface will further re-contaminate the substrate unless, as taught in '793, the entire operation is performed in a controlled environment or enclosure.

As devices become smaller and their complexity increases, it is clearly desirable to have a improved processing technique, including a method and apparatus, that aids in using environmentally safe cleaning sprays to remove unwanted organic films and particles. It is desirable to have a technique which prevents additional particles and residues from being deposited on critical surfaces during application of said impingement cleaning sprays. The complete environmental control technique should include all of the basic environmental controls of thermal control, ionization control, and providing a dry and particle free cleaning atmosphere during application of, but not negatively impacting the performance of the impinging cleaning spray.

From the above, it is seen that a method and apparatus for use with impingement cleaning devices which provides microenvironmental control of precision electromechanical substrates during application that is low-cost, easy to use, adaptable and reliable is desired. As such, there is a present need to provide a method and apparatus for protecting a substrate from atmospheric contaminants and tribocharging effects during application of cryogenic cleaning sprays, and other non-cryogenic jet cleaning impingement sprays, which is low-cost, simple and adaptable to a variety of substrates and applicators. Moreover, there is a present need for an alternative and indirect environmental management process and apparatus whereas the spray applicator and other components are outside of the cleaning zone—thereby not posing a direct contamination threat to the critical substrate surfaces. Still moreover, there is a need for an environmental control process that does not produce a direct impingement spray upon the critical surfaces being cleaned and provides heat, ions and clean-dry atmosphere to the critical surfaces and indirectly removes contaminants discharged from the surfaces during spray cleaning operations.

### SUMMARY OF THE PRESENT INVENTION

The present invention provides a low-cost, highly adaptive and selective method and apparatus to protect a device being subjected to a cryogenic impingement spray such as snow cleaning, or dry steam spray. Examples include cleaning fiber optic connector end-faces, photodiodes, CCD's and many other substrate cleaning applications. The present invention overcomes the limitations of conventional environmental control measures cited herein by providing a symmetrical and localized microenvironment encompassing the entire critical substrate features—a counterflowing and circumferential sheath of heated ionized inert dry gas which is delivered from behind the substrate surfaces being treated and which flows at an angle which is not incident to the substrate surface being treated.

The present invention employs a novel non-impingement approach which relies on molecular diffusion phenomenon to 1) convey ions, inert gas molecules and heat to treated surfaces, 2) transport moisture, particles and other residues from treated surfaces, and 3) continuously shroud the substrate within an inert gas blanket. The present invention employs a relatively laminar conical or rectangular stream of clean HEPA-filtered atmosphere which rises from the plane of the substrate to sheath and protect the substrate during application of a cryogenic cleaning spray, or non-cryogenic jet surface treatments. Using the present invention, the entire substrate is bathed in an inert, clean, ionizing and dry atmosphere which rapidly rises from the sides of the substrate and upward away from the substrate, entraining and directing the local atmosphere above the substrate away from the substrate in all directions prior to, during and following spray cleaning treatments. The present invention is performed without impeding the surface cleaning action of the impingement sprays because the cleaning action is performed within a relatively non-turbulent central region of the microenvironment—a microenvironment which is created and isolated within the gaseous partition of laminar, inert, drying, ionizing and heating gas. Also the spray cleaning jets blow the protective sheath outward during operation causing eddy currents at the plane to be formed which assist with protecting the intrusion of atmospheric contaminants into the cleaning zone.

Moreover, the present invention resolves a phenomenon observed by the present inventor that occurs with most small substrates during impingement of cryogenic cleaning sprays upon their surfaces. The pressure on the substrate surface drops well below ambient pressure as the impinging spray flows over the edges of the substrate—much like airflow over the longer curved side of an airplane wing, in accordance with the Bernoulli Principle. The low pressure dome created over the cleaning zone tends to increase atmospheric entrainment and contamination effects discussed above and causes an accumulation of snow particles and the creation of water condensates containing particles within the low-pressure dome. This prevents snow particles from impinging the underlying substrate, increasing surface contamination levels and ceasing the beneficial cleaning action of the impinging particles therein. Prior to the development of the present invention, the remedy to this negative phenomenon was to periodically start and stop the cleaning spray, or to redirect the impingement cleaning spray to alter the pressure within the cleaning zone. The method and apparatus of the present invention eliminates the pressure dome phenomenon on the substrate surface by preventing downdraft over the substrate edges. A pressurized stream of gas which flows in a direction which opposes the direction to the impinging stream creates a pressure balance and prevents the flow of the impingement cleaning spray over the edges of the substrate.

The apparatus of the present invention comprises a prophylactic—a protective device which fits over a substrate or which a substrate is placed therein, which provides an instantaneous counterflowing curtain or sheath of purging gas. The prophylactic may be constructed of any variety of materials including metals, ceramics, glasses and conductive or ESD dissipative polymers, and combinations thereof, in which is machined a cavity to accept the substrate. The cavity is laterally ported to allow pressurized gas to flow into and envelop the bottom (base) and sides of the substrate contained therein, and jet out upward (and possibly downward as well) through a small circular or rectangular space between the cavity wall and substrate—forming a circular or rectangular nozzle about the perimeter of the substrate surface to be treated. The substrate may be held within the purging cavity by means of a vacuum, manually held from behind or held by gravity alone. A dry inert gas, which may be ionized, flows at high velocity in a manner consistent with the geometry of the substrate being treated. Thus the high velocity purging jet may be circular, rectangular or any other shape as machined to form the appropriate cavity. Moreover, additional purging jets may be placed in circumferential patterns forming rings or rectangular gas jet fences about the perimeter of the substrate contained therein. Still moreover, the prophylactic may be designed to be interchangeable to accommodate any number of substrates and substrate geometries, and may be attached to the cryogenic spray applicator in such a manner as to allow for automatic placement over a substrate and performance of simultaneous counterflowing purge and spray operations.

The prophylactic approach of the present invention provides both physical (structural) and chemical (ionic) ESD prevention and control components—a “Faraday Cage” which surrounds and protects the substrate from harmful electrical charges and radiation during spray treatments. The structural element of the present prophylactic device may be designed, through incorporation of mass and type of material, to be much more efficient in banking heat. As such, the heated purge gas in direct contact with the prophylactic device heats it up and this stored heat is transferred indirectly through convective means to the protective atmosphere flowing adjacent to and away from critical substrate surfaces.

Finally, the present invention provides a process and apparatus which is adaptable to many automated cleaning and assembly operations, and is a cost- and performance-effective alternative to environmental enclosures. The present invention may be adapted to a robotic arm and integrated with the impingement cleaning spray applicator to provide automatic insertion, cleaning and treatment, and de-insertion of substrates—an in-situ ultraclean microenvironment for any type of production or assembly line.

A further understanding of the nature and advantages of the invention may be realized by reference to the latter portions of the specification and attached drawings.

### BRIEF DESCRIPTION OF THE DRAWINGS

These and other objects and advantages of the present invention will be obvious to those of ordinary skill in the art after having read the following detailed description of the preferred embodiments which are illustrated in the various figures.

FIG. 1 is a design for a simple prophylactic device for cleaning fiber optic connector end-faces.

FIGS. 2a, 2b and 2c gives the insertion and de-insertion sequences for using the exemplary prophylactic device of FIG. 1.

FIG. 3 gives the various protective gas sheath flow patterns of the exemplary prophylactic device of FIG. 1 in relation to the exemplary fiber optic connector end-face and exemplary impinging cleaning spray.

FIGS. 4a and 4b give insertion and de-insertion sequences for an exemplary vacuum-assisted prophylactic device for cleaning the surface of a photodiode with exemplary flow patterns for protective gas flows.

FIG. 5 gives the negative phenomenon associated with conventional impingement spray cleaning of small substrate surfaces.

FIG. 6 gives the positive phenomenon associated with impingement spray cleaning provided by exemplary features of prophylactic devices of the present invention.

FIG. 7 is an exemplary prophylactic device for use with rectangular substrates such as dies, CCDs and photodiodes.

FIGS. 8a, 8b and 8c give automation sequences for an exemplary integrated applicator combining an exemplary prophylactic device and impingement spray device with a simple automation device.

FIG. 9 is an exemplary prophylactic device for use with substrates such as dies, CCDs and photodiodes and shows an angular delivery of inerting gases above a substrate.

FIG. 10a is an exemplary conceptual cleaning device incorporating an exemplary prophylactic device of the present invention.

FIG. 10b is an exemplary conceptual cleaning process using the exemplary cleaning device of FIG. 10a.

FIG. 10c shows the interior components of the exemplary conceptual cleaning device of FIG. 10a.

### DETAILED DESCRIPTION OF THE INVENTION

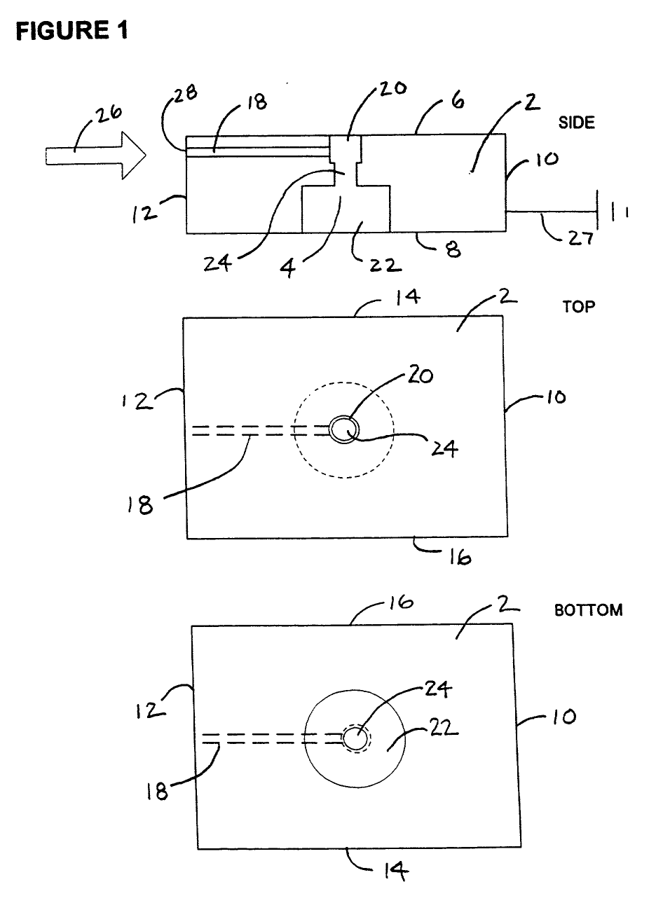

FIG. 1 is a design for a simple prophylactic device for cleaning fiber optic connector end-faces showing side, top and bottom perspectives. Referring to the figure, the body of the prophylactic (2) may be constructed of various materials including ceramics, glasses, polymers and metals which may be ESD-dissipative or non-conductive to prevent electrical corona arcing during impingement spray cleaning using low-k cleaning agents. The exemplary body (2) is machined to contain a cavity (4) which is shaped to accept the exemplary substrate (not shown) to be spray cleaned. The prophylactic body (2) contains a top side surface (6), a bottom side surface (8), a right side surface (10), a left side surface (12), a back side surface (14) and a front side surface (16). A gas port (18) is drilled from any of the side surfaces (18) into the upper chamber (20) of the central cavity (4). A lower chamber (22), which is larger in diameter than the upper chamber (20) and accepts the body of the exemplary fiber optic connector (not shown), is connected to the upper chamber (20) via a smaller central chamber (24). The central chamber (24) serves as a guide for inserting and aligning the fiber optic connector tip centrally within the upper chamber (20). Finally, pressure-regulated inert, ionized and/or heated gas (26) is introduced through an inlet port (28) into the gas port (18) which then flows into the upper chamber (20) of the central cavity (4). The gas may be clean air, nitrogen, carbon dioxide, argon and mixtures thereof. The pressure of the inlet gas (26) may be regulated to be between 10 psi to 500 psi and the temperature of the inlet gas (26) may be regulated to be between 15 C and 150 C. The inlet gas (26) may be ionized prior to introduction into the gas port (18) through the use of an in-line AC gas ionization device (not shown but available from Ion Systems, Inc.) affixed to the inlet port (28). Finally, the exemplary device may be grounded (27) using a suitable resistor (>1 Mohm) in-line to bleed off electrostatic charges without arcing.

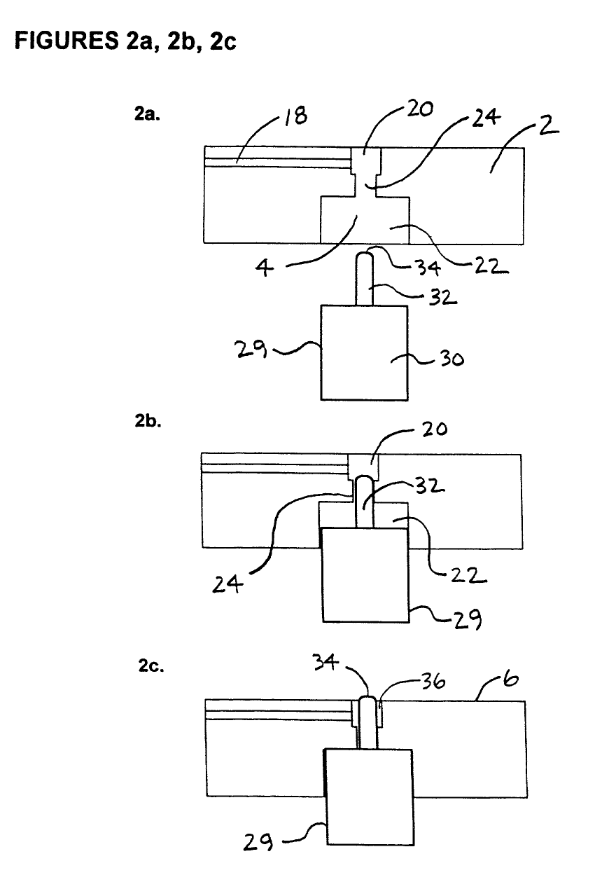

FIGS. 2a, 2b and 2c give the insertion (and de-insertion) sequences and alignments for a fiber optic connector processed with the exemplary prophylactic device of FIG. 1. Referring to FIG. 2a, the exemplary fiber optic connector (29) comprises a body (30), fiber optic tip (32), fiber optic end-face (34) and cable (not shown). Referring to FIG. 2a, the exemplary fiber optic device (29) is inserted into the lower chamber (22) with the fiber optic tip (32) centrally aligned and guided through the central chamber(24) and into the upper chamber (20). Referring to FIG. 2c, the exemplary fiber optic connector device (29) when properly inserted into the exemplary prophylactic device will have its connector end-face (34) flush the upper surface (6) of the prophylactic device and will have a small annular spacing or gap (36) about the tip (32) of the fiber optic connector (29).

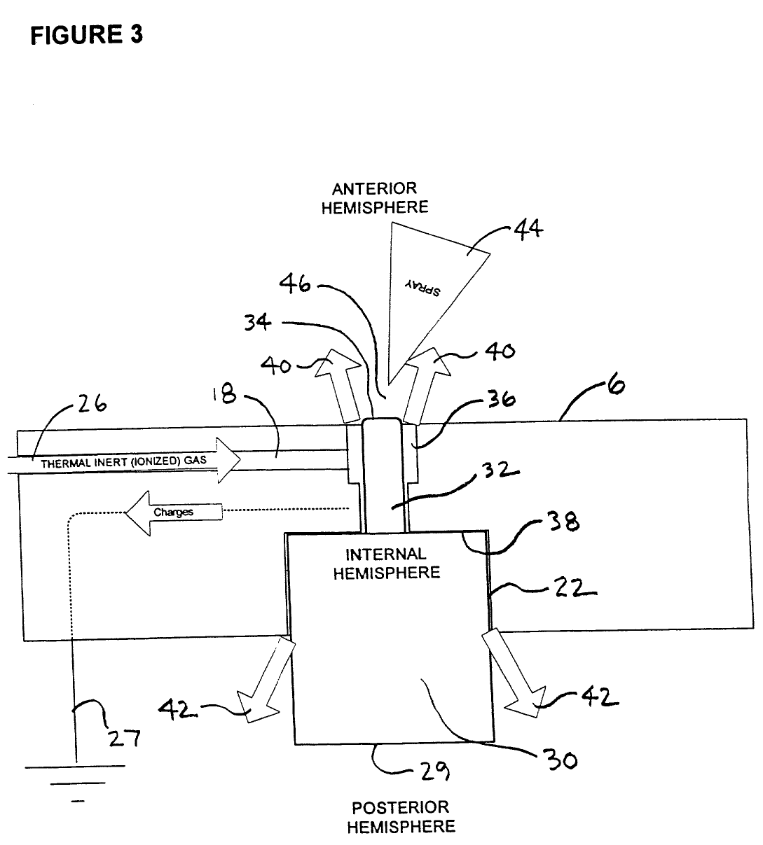

FIG. 3 gives the various protective gas sheath flow patterns of the exemplary prophylactic device of FIG. 1 and described in FIGS. 2a, 2b and 2c in relation to the exemplary fiber optic connector end-face and exemplary impinging cleaning spray. Referring to FIG. 3, the fiber optic connector (29) as fully inserted into the exemplary prophylactic device will have its end-face (34) flush or slightly above the plane of the top surface (6) and have a small annular gap (36) about the fiber optic tip (32). The fiber optic connector body (30) will be fully inserted the lower chamber (22) and pushed up flush against the upper shoulder (38) of the lower chamber (22). Thermal ionized/inert gas (26) which has been pressure- and temperature-regulated to predetermined set-points within the preferred pressure and temperature ranges flows through the gas port (18) and into the upper chamber (36). The gas builds pressure within the chamber and flows vertically with high velocity out of the chamber as indicated by flow arrows (40) forming a circular sheath flow about the tip (32) and above the surface plane (6) of the exemplary prophylactic device. The exemplary prophylactic device is purposely designed and constructed to not be gas tight with the fiber optic fully inserted. This is done so that the pressurized gas within the upper chamber also flows downward, shown as flow arrows (42), over the tip (32) and body (30) bathing the entire substrate with thermal ionized gas, Using this design, microenvironmental gas flow streams are moving in directions which are generally opposite to the plane of the critical surface to be cleaned. As shown in the figure, this provides microenvironments which are located in interior, posterior and anterior regions relative to the substrate being treated.

The exemplary cleaning spray (44) is then jetted into the interior section (46) of the protective sheath (40). The protective sheath gas flows continuously prior to, during and following spray cleaning. Finally, the entire prophylactic device may be grounded (27) to earth using a suitable resistor in-line (>1 Megaohms) to safely drain away residual electrostatic charges built up during spray cleaning.

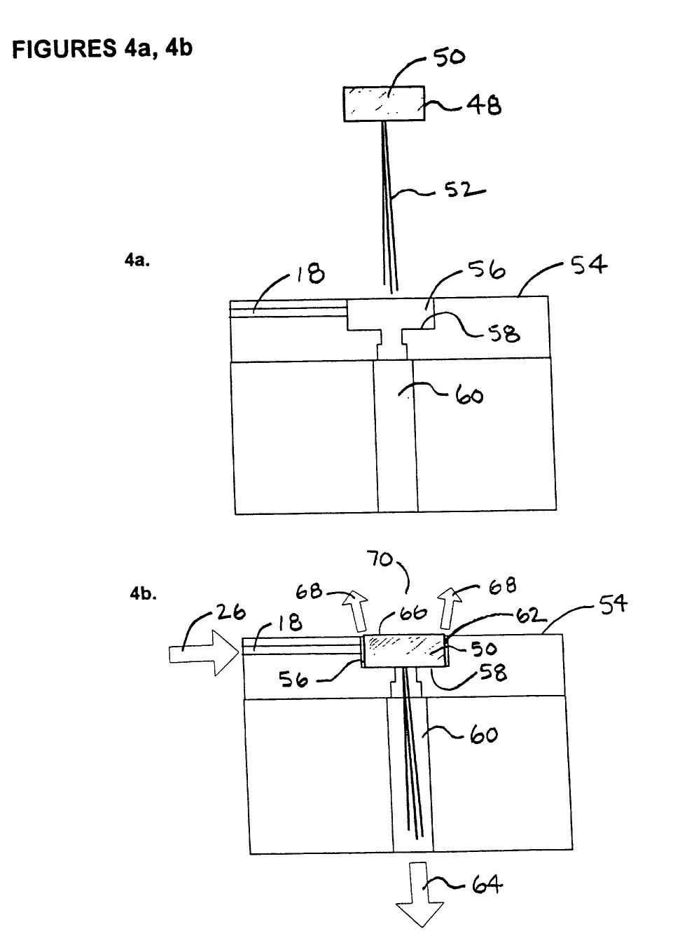

FIGS. 4a and 4b are exemplary views of a vacuum-assisted prophylactic device for cleaning the surface of a photodiode with exemplary flow patterns for protective gas flows. Referring to FIG. 4a, a prophylactic device may be constructed for virtually any type of substrate. FIG. 4a shows—a prophylactic device designed for use with cleaning photodiodes. A photodiode (48), a device that converts light impulses into electrical impulses, comprises a cylindrical electronic package (50) and one or more electrodes (52). The exemplary substrate is inserted from the top into the exemplary prophylactic device (54). The exemplary prophylactic device contains an upper chamber (56) which accepts and cradles the photodiode electronic package (50) against a lower shoulder (58) which serves as a vacuum seal. Central and lower chamber compartments (60) receive the electrodes (52) during insertion. A gas port (18) conveys pressure- and temperature-regulated thermal ionized gas into the upper chamber (56).

Referring to FIG. 4b, following insertion of the exemplary substrate, a small annular cavity (62) is formed about the electronic package (50). An external vacuum source (64) is used to create a negative pressure within the central and lower chambers (60), causing the upper atmosphere to push down upon the electronic package (50) sealing it against the lower shoulder (58). Pressure- and temperature-regulated thermal ionized gas (26) is then fed into the upper chamber (56) which flows at high velocity around the edges of the exemplary substrate and vertically away from the critical surfaces (66) as shown in the arrows (68) forming a rising circular sheath flow. The exemplary substrate surface (66) is flush with or slightly raised above the plane of the surface (54) of the exemplary prophylactic device. Moreover, as with the exemplary substrate treatment operations described in FIG. 3 above, the cleaning spray may be jetted (not shown) into the center of the sheath flow (70) during which the vacuum (64) and gas (26) flows are activated continuously.

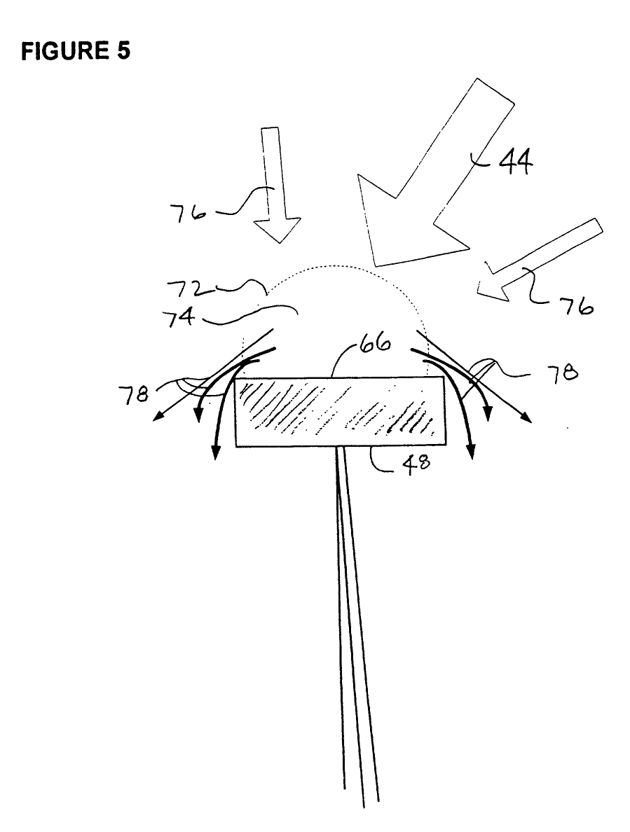

FIG. 5 gives the negative phenomenon associated with conventional impingement spray cleaning of small substrate surfaces. Referring to FIG. 5, directing a jet spray (44) against small surfaces (66), exemplary of substrates such as the photodiode (48) shown produces a low pressure dome (72) within which (74) the pressure is less than that of the ambient atmosphere (76). Streamlines (78) over the sides of the substrate lower the internal pressure, in accordance with Bernoulli's Principle. This phenomenon causes contaminants within the ambient atmosphere (76) to be condensed within the low pressure zone (74) and onto critical substrate surfaces (66).

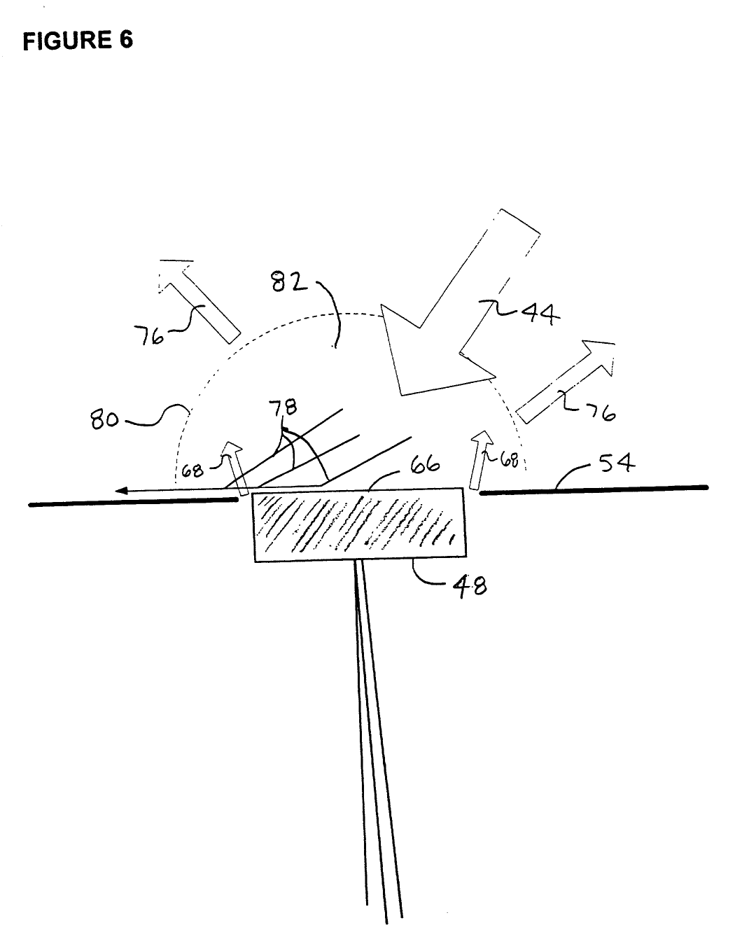

FIG. 6 gives the positive phenomenon associated with impingement spray cleaning provided by exemplary features of the prophylactic device and method of the present invention. Referring to FIG. 6, directing a jet spray (44) against small surfaces (66), exemplary of substrates such as the photodiode (48) shown, using the exemplary prophylactic device and method produces a high pressure dome (80) within which (82) the pressure is equal to or greater than that of the ambient atmosphere (76). Streamlines (78) created over the planar surfaces of the substrate (66) and prophylactic device (54) with the purging gas sheath (68) do not create a low pressure zone. This phenomenon causes contaminants contained within the ambient atmosphere (76) to be evacuated from the local cleaning area (82) and away from critical substrate surfaces (66).

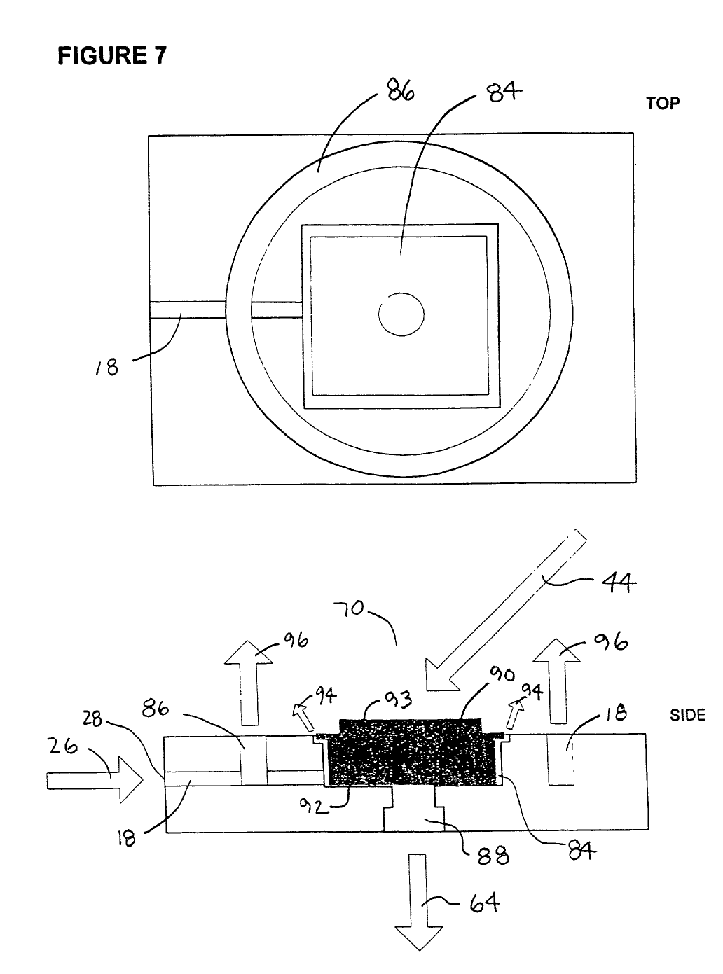

FIG. 7 gives a top view and side view of an exemplary prophylactic device for use with rectangular substrates such as dies, CCDs and photodiodes. As shown in FIG. 7, top view, the exemplary prophylactic device contains a rectangular central cavity (84) designed to accept the base of a rectangular substrate such as a flip chip device. A circumferential purge ring (86) extends about the rectangular cavity (84), both of which are connected to a common gas port (18). Referring to FIG. 7 bottom view, the exemplary prophylactic device contains a bottom vacuum port (88) which is ported into the upper central rectangular cavity (84). An exemplary rectangular substrate (90), for example a flip chip device, is placed into the cavity (84) whereupon an external vacuum (64) creates a negative pressure within the vacuum port (88), causing the upper atmosphere (70) to push down on the substrate (90), creating a gas-tight seal against the lower shoulder (92) of the upper cavity (84). Pressure- and temperature-regulated inert, ionized and ultrafiltered gas (26) is fed into and inlet port (28) which then flows though a gas port (18) and into the purge ring (86) and into the upper cavity (84). Two protective and counterflowing, relative to the substrate top surface (93), purge streams or sheath flows are created; an interior rectangular sheath flow (94) and an outer circular sheath flow (96). While the purge streams are continuously flowing, the impingement treatment stream (44) may be applied to the substrate (90) as desired.

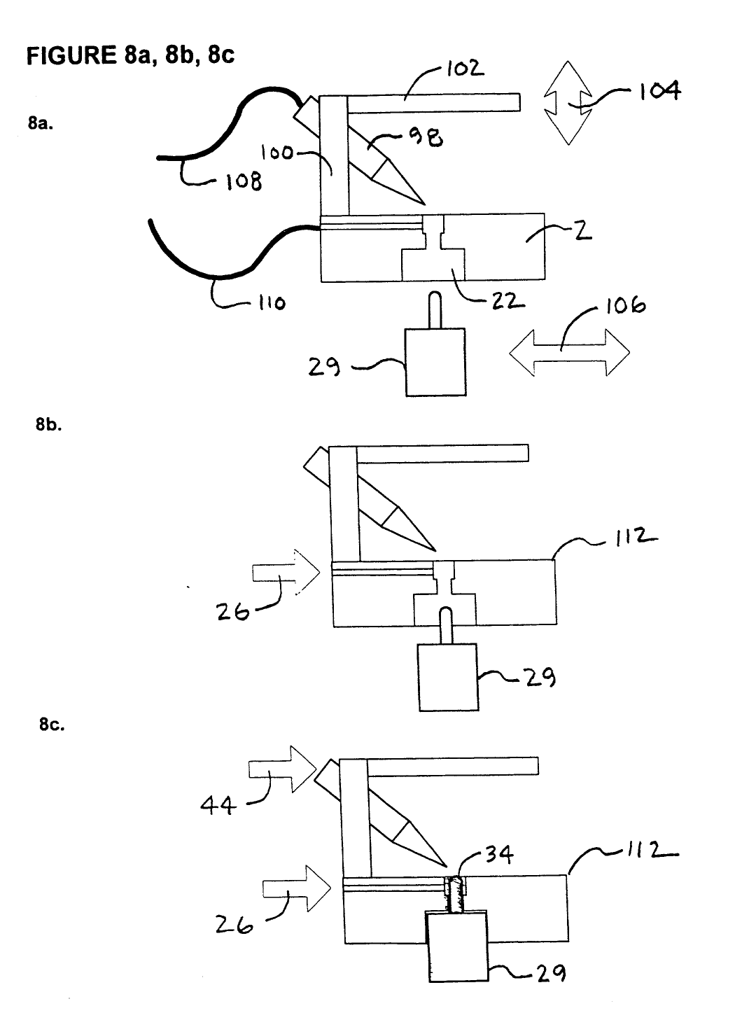

FIGS. 8a, 8b and 8c give the automation sequences for an exemplary device having an exemplary impingement spray applicator integrated with an exemplary prophylactic device used for cleaning the end-face of a fiber optic connector.

Referring to the FIG. 8a, the body of the prophylactic device (2) as shown and described using FIG. 1 herein is coupled with an impingement spray applicator (98), such as a cryogenic spray nozzle or dry steam spray nozzle, using an appropriate clamp (100). The integrated prophylactic device and spray applicator is connected to a common automation device (102). In this example, the automation device is a simple stationary y-axis robot which moves the integrated prophylactic device and spray applicator up and down as indicated by the arrow (104). The exemplary substrate (29), for example a fiber optic connector, is moved in the x-direction into a position directly aligned with the lower cavity (22) using a suitable conveyor device (not shown) as indicated by the arrow (106). Finally, the exemplary spray applicator is connected to a source of cleaning agent, for example liquid carbon dioxide or steam, via a flexible delivery line (108) and the exemplary prophylactic device is connected to a source of pressure- and temperature-regulated inert ionized and ultrafiltered gas via a flexible delivery line (110).

Having thus described the exemplary features of the integrated and automated prophylactic device and spray applicator using FIG. 8a, FIGS. 8b and 8c show the automation and fluid flow sequencing and are described as follows.

Referring to FIG. 8b, the exemplary substrate (29) is positioned under the exemplary applicator (112), as described above, whereupon the exemplary applicator (112) moves down as described in FIG. 8a (104) over the substrate (29). During this operation, the purging gas (26) begins to flow, evacuating the cavities and atmospheres surrounding the critical surfaces of the substrate (29).

Referring to FIG. 8c, the exemplary applicator (112) is positioned completed over the exemplary substrate (29) as described in FIG. 8a (104), following which the exemplary cleaning agent (44) begins to flow, treating the exposed and protected end-face (34) of the exemplary substrate (29). Reversing sequences 8a, 8b, and 8c provides for extracting the treated substrate.

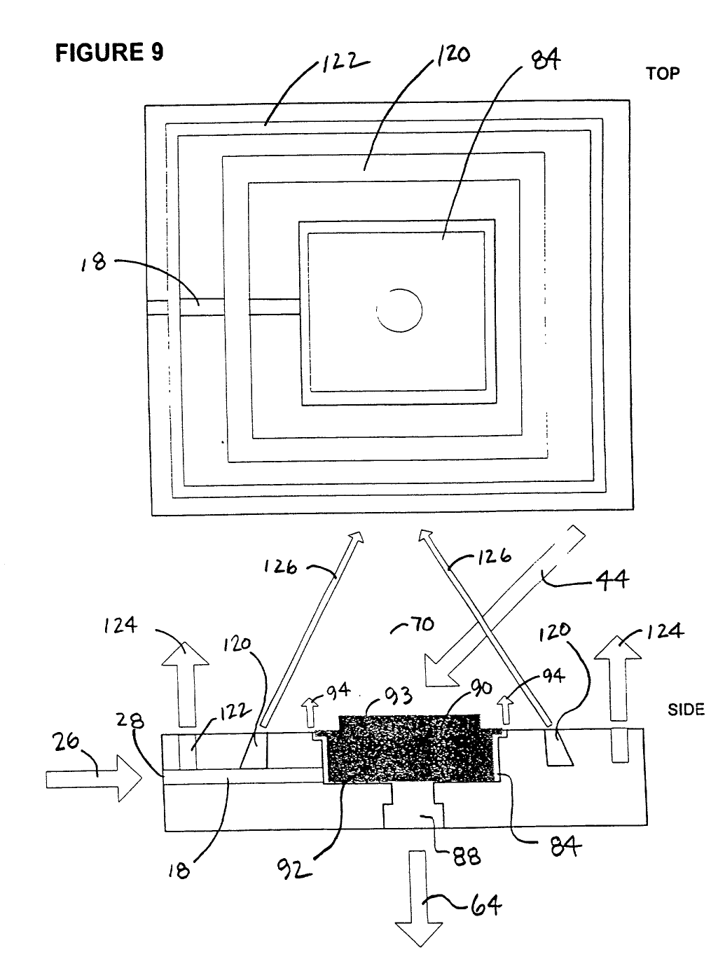

FIG. 9 is a design for a more complicated prophylactic device for larger substrates using angled purge cavities to form a pyramidal flow of inert gas environment over the top of the substrate. As shown in FIG. 9, top view, the exemplary prophylactic device contains a rectangular central cavity (84) designed to accept the base of a rectangular substrate such as a wire-bonded CCD chip. Two circumferential rectangular purge ports; an interior angled purge port (120) and a perimeter vertical purge port (122). The central cavity (84) serves as a guide for inserting and aligning the exemplary substrate (90) within the cleaning zone as well as performing posterior and anterior substrate purging. All ports are connected to a common gas port (18).

Referring to FIG. 9, bottom view, the exemplary prophylactic device contains a bottom vacuum port (88) which is ported into the upper central rectangular cavity (84). The exemplary substrate (90) is placed into the cavity (84) whereupon an external vacuum (64) creates a negative pressure within the vacuum port (88), causing the upper atmosphere (70) to push down on the substrate (90), creating a gas-tight seal against the lower shoulder (92) of the upper cavity (84). Pressure- and temperature-regulated inert, ionized and ultrafiltered gas (26) is fed into and inlet port (28) which then flows though a gas port (18) and into the exterior port (122), interior port (120) and into the substrate cavity (84). Three protective and counterflowing, relative to the substrate top surface (93), purge streams or sheath flows are created; an exterior vertical rectangular sheath flow (124), an interior vertical pyramidal sheath flow (126) and an inner rectangular substrate sheath flow (94). While the purge streams are continuously flowing, the impingement treatment stream (44) may be applied to the substrate (90) as desired.

Referring to the figure, the body of the prophylactic device may be constructed of various materials including ceramics, glasses, polymers and metals which may be ESD-dissipative, conductive or non-conductive, as desired, to prevent electrical corona arcing during impingement spray cleaning using low-k cleaning agents such as solid carbon dioxide. The inlet purge gas (26) may be chosen from clean air, nitrogen, carbon dioxide, argon and mixtures thereof. The pressure of the inlet gas may be regulated to be between 10 psi to 500 psi and the temperature of the inlet gas may be regulated to be between 15 C and 150 C. The inlet gas may be ionized prior to introduction into the gas port (18) through the use of an in-line AC gas ionization device (not shown but available from Ion Systems, Inc.) affixed to the inlet port (28). The exemplary prophylactic device may be grounded to drain electrostatic charges and may be thermally conductive to bank heat within the cleaning zone during spray operations.

### EXAMPLE APPLICATION

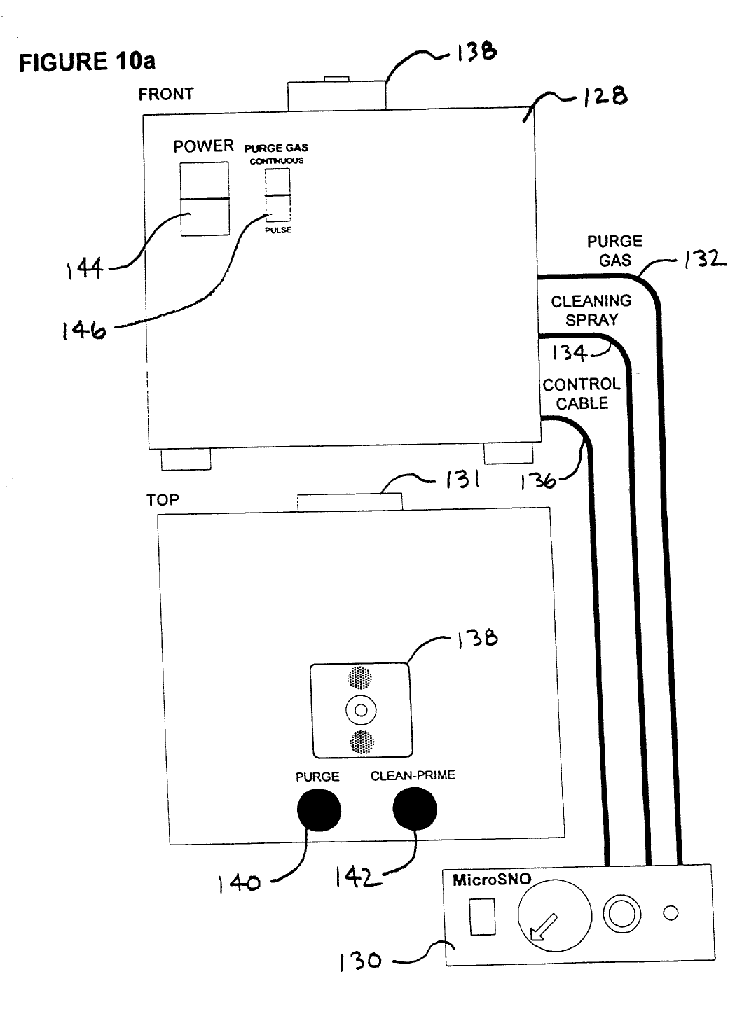

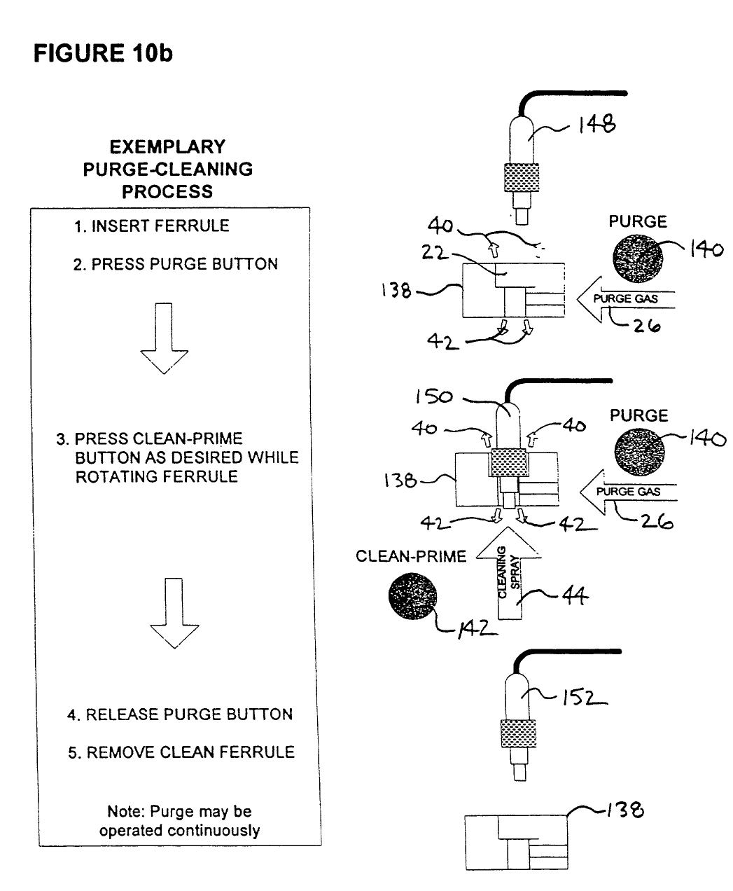

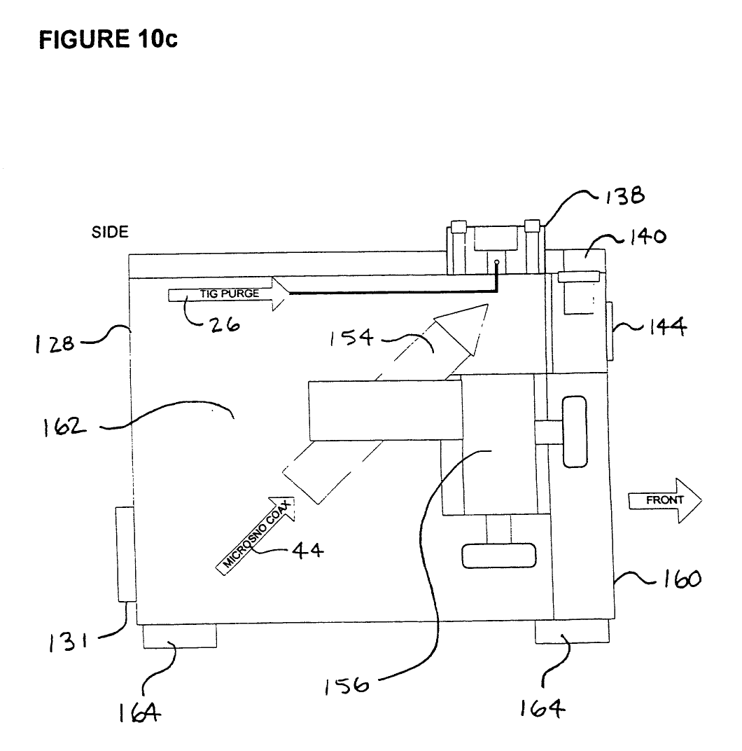

Referring to FIG. 10a, the exemplary fiber optic end-face cleaning system includes a end-face spray cleaning applicator (128) utilizing the exemplary prophylactic device of the present invention and is coupled with an exemplary C02 snow spray cleaning system (MicroSno Model MS2000, Deflex Corporation) (130). The exemplary spray cleaning applicator (128) uses an enclosure with a rear-mounted 3″ vent port (131) for connection to a house exhaust system to remove the exhausted contaminants from the cleaning zone. As shown in the figure, a, purge gas line (132), cleaning spray line (134), and a control cable (136) are interfaced between the exemplary cleaning applicator (128) and spray generation system (130). Affixed to the top side of the exemplary cleaning applicator is a screw mounted purge block adaptor assembly (138), designed and operated in accordance with FIGS. 1, 2a, 2b, 2c and 3 descriptions herein, which can be designed for any number of fiber optic ferrule designs and other substrates to be cleaned. The exemplary purge block adaptor is ESD dissipative, resistively grounded, and ported for delivery of a low-medium pressure (10-100 psi), dry (<1 ppm H₂O), ultrafiltered (0.01 micron), heated (70F-212F) and ionized (24V AC) purge gas. Also located on the top front of the cleaning applicator are two capacitive finger touch controls for actuating pulse purge (140) and spray cleaning-priming (142) operations, described below. Finally, the front console contains a fused main power switch (144) and a purge gas control switch (146) for continuous (“on”) or pulse purge control (“off”) as shown. The cleaning spray generator may be located at a convenient location remote from the spray applicator with the cable and fluids connection lines connected to the cleaning applicator as shown.

Referring to FIG. 10b, an operator inserts a ferrule assembly (148) into the purge block adaptor (138) and specifically into the bottom cavity (22) and presses the “Purge” capacitive finger button (140). This causes the interior of the purge block adaptor and ferrule assembly, and anterior (40) and posterior (42) sections of the ferrule assembly to be bathed with ultrafiltered, heated, ionized gas—Thermal-Ionized/Inert Gas (26), as shown. Following this, the operator may press the “Clean-Prime” capacitive finger button (142) as many times and as long as necessary while maintaining the purge (140) operation to deliver periodic pulses of cleaning spray (44). Following this operation, the ferrule assembly (150) is left within the purge block adaptor for a few seconds, the “Purge” button (140) is released, and the cleaned, dry and deionized ferrule (152) is withdrawn from the purge block adaptor (138). The operator may rotate the connector in +/−180° clockwise and counterclockwise rotations during the spray cleaning operation(s). The procedure may be repeated as required to produce the desired cleanliness. The purge block adaptor and control buttons are centrally located on the top side to allow for both right and left-handed operation of the cleaning applicator using one hand to insert, rotate, de-insert a ferrule assembly and the second hand to perform the finger control buttons.

Finally, the purge block adaptor design provides a means for enlarging the apparent surface area of small critical surfaces (i.e., end face) exposed to high pressure impingement cleaning sprays. This feature normalizes and equalizes the cleaning spray pressure across the entire small critical surface. Without this feature present, the over-spray and down-draft of the spray particles over the edges of a small critical surface create a low pressure zone over the cleaning target in accordance with the Bernoulli Principle—causing the cleaning operation to be negatively impacted.

FIG. 10c shows a partial side view of the interior of the conceptual cleaning system. Contained within the fully-enclosed cleaning applicator are a coaxial snow spray nozzle (154) mounted in a precision adjustable rack and pinion stage with a ball pivot (156). The spray nozzle (154) may be adjusted up to 60 mm in the X-Y-Z orientations with spray angle adjustment using said control knobs and a ball pivot assembly (156). The base (158) and faceplate (160) may be constructed of passivated stainless steel. The base may contain rubber feet (164) and a rear-mounted vent port (131) may be connected to a suitable ventilation pipe to evacuated accumulated gases and vapors within the interior space (162) of the exemplary cleaning cabinet (128).

Although the preferred embodiments of the present invention have been shown and described, it should be understood that various modifications and rearrangements may be resorted to without departing from the scope of the invention as disclosed herein.

I claim:

1. A an apparatus for spray cleaning a substrate comprising:
a device having
a body with opposing first and second surfaces;
a cavity extending from the first surface to the second surface for receiving a substrate to be treated, the cavity forming a spray cleaning zone in the first surface; and
a gas inlet port in fluid communication with the cavity;
a gas supply for supplying gas to the gas inlet port; and
a spray applicator for directing a cleaning spray at the spray cleaning zone.

2. A method for treating a substrate
inserting a substrate having a surface to be spray cleaned into a cavity in a device, so that the surface to be spray cleaned is exposed, the device comprising a body with opposing first and second surfaces, the cavity extending from the first surface to the second surface, and a gas inlet port in fluid communication with the cavity; and
supplying a gas through the fluid inlet, so that the gas contacts the substrate in the cavity.

3. The method in accordance with claim 2 wherein the gas is air, nitrogen, carbon dioxide, argon or mixtures thereof.

4. The method in accordance with claim 3 wherein the gas has a pressure between 10 psi and 500 psi.

5. The method in accordance with claim 4 wherein the gas has a temperature of between 15° C. and 150° C.

6. The method in accordance with claim 4 wherein the gas is ionized.

7. The method in accordance with claim 1 wherein the substrate is an optical fiber, a fiber optic connector, a fiber optic connector end face, a photodiode, a die, a sensor or a CCD.

8. The apparatus of claim 1 wherein the body is formed of an ESD-dissipative or non-conducting material.

9. The apparatus of claim 1 further comprising a ground for the body.
